(19) United States
(12) Patent Application Publication
(10) Pub. No.: US 2024/0029150 A1
(43) Pub. Date: Jan. 25, 2024

(54) METHODS AND SYSTEMS FOR AUTHENTICATED DISTRIBUTION UPON OCCURRENCE OF A TRIGGERING EVENT USING BLOCKCHAIN

(71) Applicant: WILLPORTTRUST LLC, San Diego, CA (US)

(72) Inventor: Doris H. SCHWARTZ, San Diego, CA (US)

(73) Assignee: WILLPORTTRUST LLC, San Diego, CA (US)

(21) Appl. No.: 18/169,922

(22) Filed: Feb. 16, 2023

Related U.S. Application Data
(63) Continuation of application No. 17/097,364, filed on Nov. 13, 2020, now abandoned.
(60) Provisional application No. 62/947,723, filed on Dec. 13, 2019.
(60) Provisional application No. 62/937,127, filed on Nov. 18, 2019.

(51) Int. Cl. G06Q 40/02; H04L 9/06; G06Q 50/18; G06Q 20/38

(52) U.S. Cl. CPC G06Q 40/02; H04L 9/0618; G06Q 50/186; G06Q 20/389; G06Q 40/06

(57) ABSTRACT

Disclosed are systems and methods that includes at least one hardware processor and a memory storing instructions that, when executed by the at least one hardware processor, cause the at least one hardware processor to perform operations including receiving a request for a trust distribution between a first user and a second user, wherein the request initiated by the system upon occurrence of a triggering event.

### CROSS-REFERENCE

This application is a continuation of U.S. application of Ser. No. 17/097,364 filed Nov. 13, 2020, which claims the benefit of U.S. Provisional Application No. 62/937,127, filed Nov. 18, 2019, entitled Authenticated Voucher for Distribution of Funds Upon Occurrence of a Triggering Event Using Blockchain, and U.S. Provisional Application No. 62/947,723,filed Dec. 13, 2019, entitled Authenticated Distribution of Funds Upon Occurrence of a Triggering Event Using Blockchain, which applications are incorporated herein in its entirety by reference.

This application is related to U.S. Utility application Ser. No. 17/097,131 filed concurrently herewith entitled Systems and Methods for Authenticated Voucher Distribution Using Blockchain and U.S. Utility application Ser. No. 17/097,279 filed concurrently herewith entitled Systems and Methods for Authenticated Trust Distribution Using Blockchain both of which claim ultimate priority to U.S. Provisional Application No. 62/937,127, filed Nov. 18, 2019, entitled Authenticated Voucher for Distribution of Funds Upon Occurrence of a Triggering Event Using Blockchain, which applications are incorporated herein in their entirety by reference,

### BACKGROUND

A trust is an estate planning tool that can help pass and preserve wealth efficiently and privately. One benefit of a trust is that it can help reduce estate taxes. Another benefit of a trust is that the funds can be distributed more quickly. A trust provides a mechanism to distribute retirement assets as planned. However, the cost of forming a trust can be prohibitive for most people.

What is needed is a way to create and administer a trust which is cost effective.

### SUMMARY

Disclosed are systems and methods for administering a trust. The system provides for the electronic transfer of a funds on a schedule following a triggering event. The system uses a secure time forward delivery system. The systems and methods are configurable to be integratable into a financial or insurance institution's existing digital delivery framework or configurable to operate as a stand-alone platform. Integrity of the system can be provided with the use of, for example, blockchain and/or biometric data.

An aspect of the disclosure is directed to systems comprising: at least one hardware processor; and a memory storing instructions that, when executed by the at least one hardware processor, causes the at least one hardware processor to perform operations in a networked computing environment comprising: receiving a request to create a trust from a requestor; creating a trust blockchain; obtaining recipient information from the requestor; appending the recipient information to a trust blockchain; obtaining one or more trust source information from the requestor; appending the one or more trust source information to the trust blockchain; obtaining an advisor information from the requestor; appending the advisor information to the trust blockchain; generating the trust wherein the trust comprises a control logic configured to control access to the trust based on obtaining verification of a condition for trust and the control logic is executed using the hardware processor configured to receive a first instruction to administer the trust; and appending the trust to the trust blockchain. Instructions can further comprise one or more of obtaining a marital status from the requestor; obtaining spousal information from the requestor; obtaining spousal agreement from a spouse of the requestor; confirming the marital status; generating a marital status completion block; and appending the marital status completion block to the trust blockchain. In some configurations, the system can comprise one or more of: obtaining a personalization input from the requestor for the one or more recipients; generating a personalization completion block; and uploading the personalization completion block to the trust blockchain. Additionally, instructions can further comprise one or more of: creating an account set-up form; creating a management agreement; creating an account transfer form; creating a margin agreement; creating an options agreement; creating a money movement agreement; generating a distribution documents completion block containing the one or more created forms and agreements; and appending the distribution documents completion block to the trust blockchain. The system can also be configured to configured to generate a unique hash value for each of the documents reviewed and signed based on a secure hash algorithm in real time and store each unique hash value on the distribution blockchain. Instructions can further comprise one or more of: notifying the recipient of a distribution under the trust; obtaining a distribution location from the recipient; making a distribution to the recipient; generating a distribution delivery completion block; and appending the distribution delivery completion block to the distribution blockchain.

Another aspect of the disclosure is directed to computer-implemented methods for account creation in a networked computing environment comprising: receiving a request to create a trust from a requestor; creating a trust blockchain; obtaining recipient information from the requestor; appending the recipient information to a trust blockchain; obtaining one or more trust source information from the requestor; appending the one or more trust source information to the trust blockchain; obtaining an advisor information from the requestor; appending the advisor information to the trust blockchain; generating the trust wherein the trust comprises a control logic configured to control access to the trust based on obtaining verification of a condition for trust and the control logic is executed using the hardware processor configured to receive a first instruction to administer the trust; and appending the trust to the trust blockchain. Instructions can further comprise one or more of obtaining a marital status from the requestor; obtaining spousal information from the requestor; obtaining spousal agreement from a spouse of the requestor; confirming the marital status; generating a marital status completion block; and appending the marital status completion block to the trust blockchain. In some configurations, the method can comprise one or more of: obtaining a personalization input from the requestor for the one or more recipients; generating a personalization completion block; and uploading the personalization completion block to the trust blockchain. Additionally, instructions can further comprise one or more of: creating an account set-up form; creating a management agreement; creating an account transfer form; creating a margin agreement; creating an options agreement; creating a money movement agreement; generating a distribution documents completion block containing the one or more created forms and agreements; and appending the distribution documents completion block to the trust blockchain. The method can also be configured to configured to generate a unique hash value for each of the documents reviewed and signed based on a secure hash algorithm in real time and store each unique hash value on the distribution blockchain. Instructions can further comprise one or more of: notifying the recipient of a distribution under the trust; obtaining a distribution location from the recipient; making a distribution to the recipient; generating a distribution delivery completion block; and appending the distribution delivery completion block to the distribution blockchain.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 5,878,140 A to Chaum issued Mar. 2, 1999 for Limited-Traceability Systems;

U.S. Pat. No. 9,342,831 B1 to Davis issued May 17, 2016 for Facilitating Same Day Payment Transactions;

U.S. Pat. No. 9,342,741 B2 to Amtrup issued May 17, 2016, for Systems, Methods and Computer Program Products for Determining Document Validity;

U.S. Pat. No. 10,142,347 B2 to Kurian issued Nov. 27, 2018, for System for Centralized Control of Secure Access to Process Data Networks;

U.S. Pat. No. 10,164,779 B2 to Uhr et al., issued Dec. 25, 2018, for System for Issuing Public Certificate on Basis of Block chain, and Method for Issuing Public Certificate on Basis of Block chain by Using Same;

U.S. Pat. No. 10,331,868 B2 to Park issued Jun. 25, 2019, for User Authentication Method and System Using Variable Keypad and Biometric Identification;

U.S. Pat. No. 10,332,115 B2 to Donovan et al., issued Jun. 25, 2019, for Systems and Methods for Processing Metadata Statements in Payment Flows;

U.S. Pat. No. 10,798,094 B2 to Wei issued Oct. 6, 2020, for Blockchain-based account management;

U.S. Pat. No. 10,798,180 B1 to Gracey et al. issued Oct. 6, 2020 for Systems And Methods For Optimizing Information Collaboration; and

US 2019/0005470 A1 to Uhr, et al., published Jan. 3, 2019, for Accredited Certificate Issuance System Based on Block chain and Accredited Certificate Issuance Method Based on Block chain Using Same, and Accredited Certificate Authentication System Based on Block chain and Accredited Certificate Authentication Method Based on Block chain Using Same.

### BRIEF DESCRIPTION OF THE DRAWINGS

The novel features of the invention are set forth with particularity in the claims. A better understanding of the features and advantages of the present invention will be obtained by reference to the following detailed description that sets forth illustrative embodiments, in which the principles of the invention are utilized, and the accompanying drawings of which:

FIG. 1 is a block diagram illustrating a blockchain system environment suitable for use with the disclosed trust distribution system;

FIG. 2 is an overview of an exemplar trust distribution process;

FIG. 3A is a flow diagram illustrating a portion of the process for creating a user trust account;

FIG. 3B is a flow diagram illustrating of a trust recipient allocation process;

FIG. 4 is a flow diagram illustrating a trust distribution process which can occur after receiving a death notice;

FIG. 5 is a deployment of funds process; and

FIGS. 6A-6D are trust distribution flow diagrams.

### DETAILED DESCRIPTION

### I. BLOCKCHAIN PROCESS

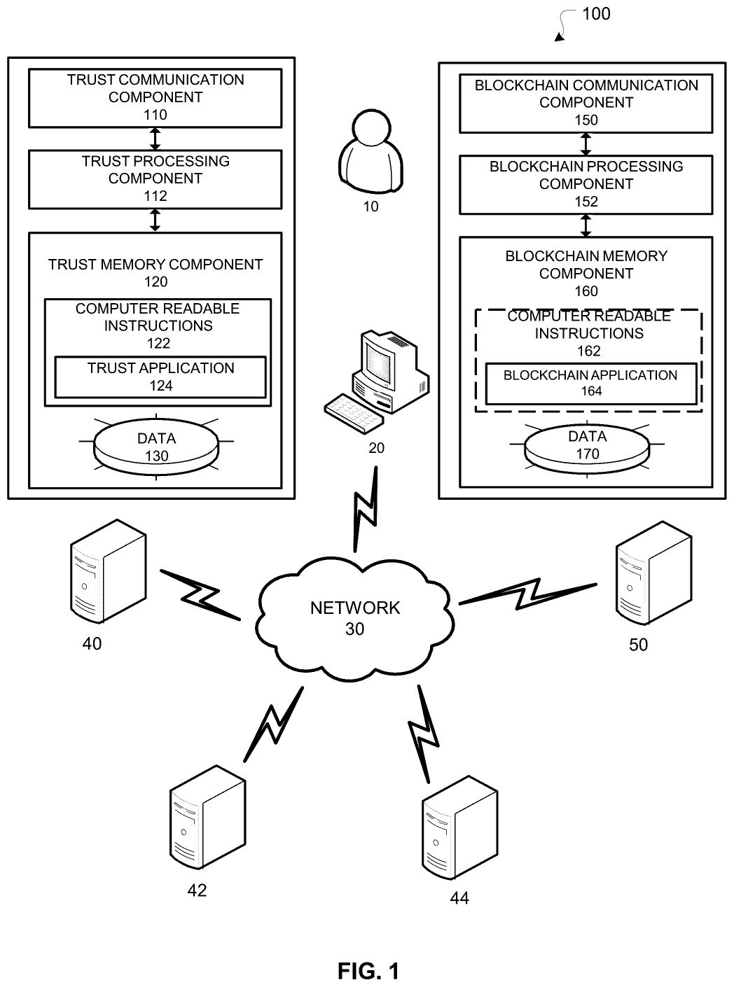

Turning now to FIG. 1, a blockchain and trust system 100 generally comprises one or more blockchain communication components 150, one or more blockchain processing components 152, and one or more blockchain memory components 160. The one or more blockchain processing components 152 are operatively coupled to the one or more blockchain communication components 150 and the one or more blockchain memory components 160. As will be appreciated by those skilled in the art, processing components and processors generally includes circuitry used for implementing the communication and/or logic functions of a particular system. For example, a blockchain processing component 152 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more blockchain processing components 152 may include functionality to operate one or more software programs based on blockchain computer-readable instructions 162 thereof, which may be stored in the one or more blockchain memory components 160.

The one or more blockchain processing components 152 use the one or more blockchain communication components 150 to communicate with the network 30 and other components on the network 30, such as, but not limited to, the user computer systems 20, first entity systems 40, second entity systems 42, Nth entity systems 44, or other like systems. As such, the one or more blockchain communication components 150 generally comprise a wireless transceiver, modem, server, electrical connection, electrical circuit, or other component for electronically communicating with other components on the network 30. The one or more blockchain communication components 150 may further include an interface that accepts one or more network interface cards, ports for connection of network components, Universal Serial Bus (USB) connectors and the like.

A blockchain can be comprised of one or more blocks (digital information) and/or sub-blockchains which can also be comprised of one or more blocks, in a chain (database). Blocks store information about transactions. A single block on a blockchain can store as much as 1 MB of data (e.g., a few thousand transactions per block). Once a process is completed, the block can be configured so that it cannot be written to following completion. Data, e.g. event records, blocks and/or blockchains (such as sub-blockchains) can be appended to a blockchain. The blockchain distributed ledger provides transparency and immutability. Changes to the blockchain ledger are viewable by all permissioned participants and the corresponding transactions cannot be altered or deleted. Additionally, the system is configurable to generate a unique hash value for each of the block entries, such as documents reviewed and signed, based on a secure hash algorithm in real time and store each unique hash value on the voucher blockchain.

As further illustrated in FIG. 1, the blockchain system 50 comprises blockchain computer-readable instructions 162 stored in the blockchain memory component 160, which in one embodiment includes the blockchain computer-readable instructions 162 of the blockchain application 164. In some embodiments, the one or more blockchain memory components 160 include one or more blockchain data stores 170 for storing data related to the blockchain systems 50, including, but not limited to, data created, accessed, and/or used by the blockchain application 164.

The blockchain systems 50, and the components therein, may be one or more private blockchains, one or more public blockchains, and/or one or more hybrid blockchains. Moreover, the blockchain systems 50 may be located in or associated with the other systems described herein.

Users 10 may access the blockchain application 164 on the one or more blockchain systems 50, or a portion thereof stored on other systems (e.g., a portion of the blockchain application 164 stored on the user computer systems 20 or first entity systems 40, second entity system 42 or nth entity system 44), or through other applications, through a user computer system 20. The user computer system 20 may be a desktop, laptop, tablet, mobile device (e.g., smartphone device, or other mobile device), or any other type of computer that generally comprises one or more trust communication components 110, one or more trust processing components 112, and one or more trust memory components 120.

The one or more trust processing components 112 are operatively coupled to the one or more trust communication components 110, and the one or more trust memory components 120. The one or more trust processing components 112 use the one or more trust communication components 110 to communicate with the network 30 and other components on the network 30, such as, but not limited to, the blockchain systems 50, the first entity systems 40, the second entity systems 42, the Nth entity systems 44, or other systems. As such, the one or more trust communication components 110 generally comprise a wireless transceiver, modem, server, electrical connection, or other component for electronically communicating with other components on the network 30. The one or more blockchain communication components 150 may further include an interface that accepts one or more network interface cards, ports for connection of network components, Universal Serial Bus (USB) connectors and the like. Moreover, the one or more trust distribution communication components 110 may include a keypad, keyboard, touch-screen, touchpad, microphone, mouse, joystick, other pointer component, button, soft key, and/or other input/output component(s) for communicating with the users 10.

As illustrated in FIG. 1, the user computer systems 20 may have a trust computer-readable instructions 122 stored in the one or more trust memory components 120, which in one embodiment includes the trust computer-readable instructions 122 of trust distribution applications 124, such as dedicated applications (e.g., apps, applet, or the like), portions of dedicated applications, web browser or other apps that allow access to applications located on other systems, or the like. As previously discussed, the blockchain application 164, or a portion thereof, may be stored on each of the user computer systems 20.

As illustrated in FIG. 1, the first entity systems 40, the second entity systems 42, the Nth entity systems 44, or other systems are operatively coupled to the blockchain systems 50 and/or user computer systems 20, through the network 30. These systems have components that are the same as or similar to the components described with respect to the blockchain systems 50 and/or user computer systems 20 (e.g., one or more communication components, one or more processing components, and one or more memory devices with computer-readable instructions of one or more applications, one or more datastores, or the like). Thus, the first entity systems 40, the second entity systems 42, the Nth entity systems 44, or other systems communicate with the blockchain systems 50, the user computer systems 20, and/or each other in same or similar way as previously described with respect to the blockchain systems 50 and/or the user computer systems 20. The first entity systems 40, second entity systems 42, Nth entity systems 44 may be made up of one or more user computer systems 20, one or more of the blockchain systems 50, or other entity systems that act as nodes which are utilized to store, disseminate, and/or validate event information for events within the blockchain. It should be further understood that the blockchain systems 50 may be separate systems and/or a part of each user computer system 20, and/or first entity systems 40, second entity systems 42, Nth entity systems 44.

Rather than utilizing a centralized database to access, view, store, disseminate, and/or validate information, the present trust distribution system utilizes a decentralized blockchain configuration or architecture to order to allow users 10 to access, view, store, disseminate, and/or validate information, or take another action related to an event. Such a decentralized blockchain configuration ensures accurate mapping and validation of event information, and provides a secured network over which information may be validated. Accordingly, blockchain configurations may be utilized with respect to any type of information, such as, but not limited to maintaining an accurate ledger of information, such as resource transfer information (e.g., transaction, asset transfer, sale, or other like transfer of value information), personal information, credit history information, or the like, in order to provide validation, such as validation of resource transfers, or access to personal information, or the like.

As will be appreciated by those skilled in the art, a blockchain, or “blockchain,” is a distributed database that maintains a list of data records, the security of which is enhanced by the distributed nature of the blockchain. A blockchain typically includes several nodes, which may be one or more entities, systems within an entity, machines, computers, databases, data stores, or the like operably connected with one another. For example, the various systems described with respect to FIG. 1, or systems within the systems described with respect to FIG. 1 may be nodes. In some aspects of the disclosure, an entity may be a node of a blockchain, and internal users or external users 10 may access the entity systems in order to take actions with respect to an event. In other aspects of the various systems, any nodes may or may not be grouped together and associated with the entity. Each of the nodes or multiple nodes can be maintained by different entities, or components within an entity, and as such different systems within an entity or between entities may act as nodes.

A blockchain typically works without a central repository or single administrator. However, a network of nodes within a single entity or group of entities may together serve as a central repository or single administrator that can control access to the blockchain that is associated with a plurality of different nodes. One application of a blockchain is the public ledger of resource transfers for cryptocurrencies, such as used in bitcoin. In this use of a blockchain, the data records recorded in the blockchain are enforced cryptographically and stored on the nodes of the blockchain within a trust distribution system. The distributed blockchain network disclosed herein can have at least one private blockchain portion and in some cases a public blockchain portion. The system allows users to take actions (e.g, accessing, viewing, storing, disseminating, validating, or the like) with respect to the distribution. Each block is a time-stamped series of an immutable record of data that is managed by cluster of computers not owned by any single entity. Each of these blocks of data (i.e. block) are secured and bound to each other using cryptographic principles (i.e. chain). Portions of the distributed ledger can form a smart contract which includes an offer, acceptance and consideration.

A blockchain provides numerous advantages over traditional databases. For example, with respect to utilizing a blockchain for resource transfer information, a large number of nodes of a blockchain may reach a consensus regarding the validity of a resource transfer contained on a decentralized resource transfer ledger. Similarly, when multiple versions of a document or resource transfer exits on the ledger, multiple nodes can converge on the most up-to-date version of the resource transfer. For example, in the case of a virtual currency resource transfer, any node within the blockchain that stores or validates the resource transfer, can determine within a level of certainty whether the resource transfer can take place and become final by confirming that no conflicting resource transfers (i.e., the same currency unit has not already been spent) are confirmed by the blockchain elsewhere on other nodes.

The blockchain typically has two primary types of records. The first type is the event type (e.g., resource transfer type, document type, or the like), which consists of the actual data stored in the blockchain. The second type is the block type, which are records that confirm when and in what sequence certain events (e.g., resource transfers, or the like) became recorded as part of the blockchain. Events (e.g., resource transfers, or the like) are created by participants using the blockchain in its normal course of business, (for example, when someone sends cryptocurrency to another person), blocks are created by users known as “miners” who use specialized software/equipment to create the blocks for the event. Users of the blockchain create blocks for the events (e.g., resource transfers, or the like), which are passed around to various nodes of the blockchain. A “valid” resource transfer is one that can be validated based on a set of rules that are defined by the particular system implementing the blockchain.

Blockchains are typically decentralized. A distributed ledger (e.g., a decentralized ledger) is maintained on multiple nodes of the blockchain. One node in the blockchain may have a complete or partial copy of the entire ledger or set of events (e.g., resource transfers, or the like) and/or blocks on the blockchain. Events (e.g., resource transfers, or the like) are initiated at a node of a blockchain and communicated to the various other nodes of the blockchain. Any of the nodes, or users of the nodes, which have access to the blockchain to validate an event, add the event to its copy of the blockchain, and/or broadcast the event (e.g., resource transfer or the like) its validation (in the form of a block) and/or other data to other nodes. This other data may include time-stamping.

Various other applications of blockchains may be utilized for the trust distribution application. These include contract execution, analyst reporting, financial reporting, synchronous/asynchronous communication, controlling access to or dissemination of timeline, personal, and/or financial data and even a general purpose deployment of decentralized applications. As such, blockchains may be utilized to access, view, store, create, disseminate, and/or validate any type of event information, or take any other type of action with respect to event information associated with an event.

In various aspects, the blockchain may be configured with a set of rules (otherwise described herein as “limits”) to dictate what actions may be taken by users and/or nodes for various events, how information may be accessed, created, stored, disseminated, and/or validated, and/or how the network communicates information throughout the one or more blockchains across the nodes of various entities associated with the nodes (e.g., supports the nodes on the entity systems). In some aspects, the rules dictate that an originating node (i.e., a node through which a resource transfer was initiated) must approve all actions for events mapped to that node. In some aspects, the rules dictate that some or all actions for events may be approved by one or more validator nodes without further input from the originating node. In some such cases, the rules dictate that additional information is needed in determining whether an action for an event should be approved. In other aspects, the validating node must reach out to the originating node in certain situations as dictated by the rules. For example, if the action for the event, such as validating a resource transfer, is in any way, indicated to be a faulty or invalid (due to some information present on the blockchain), then the rules may dictate that the validating node communicate with the originating node to confirm or deny validation of the event.

In some aspects, the validator may approve the event (e.g., resource transfer, or the like) without communicating with the originating node. In such a case, the validator (or a group or all of validators if multiple or universal validations, respectively, are required by the rules), can approve the action for the event based solely on the information contained in the blockchain. Thus, if an action for an event is requested and a validator receives the action for the event, it can check the actions for the event against its ledger to determine whether an originating node has validated the event. If so, then the validator may approve the action for the event. In this regard, the action for the event may be approved very quickly, and in some cases, in real-time or near real-time.

In various aspects, any of the blockchain nodes may be a validator or a miner that validates events (e.g., resource transfers, or the like). In some aspects, a number of the nodes must validate an event (e.g., resource transfer, or the like) in order for the event to be approved. For example, in one embodiment, two or three nodes must validate the authenticity of the event, or portions thereof, before the event may be approved. As noted above, in some instances, the rules of the blockchain and/or rules specific to particular originating entities or validators dictate that validators cannot approve events without confirming available information (e.g., funds used in a resource transfer). In some cases, the available information is already associated with an alias on the public blockchain, or associated with a customer within an entity controlling a private blockchain, but in other cases, the validator on the blockchain must communicate with the originating entity in order to request approval of the event (e.g., resource transfer, or the like).

In some aspects, the rules may only be changed by the originating node (maintained by an originating entity or entities that control the blockchain) to ensure the validity of a change to a rule. In some cases, particularly in cases where one or more nodes have raised a concern that an event is not valid, the originating node may be contacted for verification of the event.

In various aspects, the event, or information for the event, is stored and executed from one or more systems and is not placed on the public blockchain itself, and instead is located on a private portion of the blockchain. In some aspects, the event, or information for the event, is only stored and executed from a subset of the nodes of the blockchain, which, in some aspects, are synonymous with validator nodes and in other aspects are not synonymous with the validator nodes. In some aspects, placeholder(s) for the event (e.g., resource transfers, or the like) indicating that the event exists and/or a description of the event, is accessible from private blockchains and may be placed on the public blockchain. The placeholder(s) may be identifiers (e.g., characters, or the like) and/or a description of the event. In some cases, the event may be executed only by the designated one or more systems (e.g., on the private blockchain, or on a private portion of a blockchain). Such systems may utilize a key or other security mechanism(s) in order to ensure only certain nodes are allowed access to the information related to the private blockchain portion. In some cases, this configuration may result in additional security instead of placing the event on the public blockchain for any node to execute.

### II. TRUST OVERVIEW

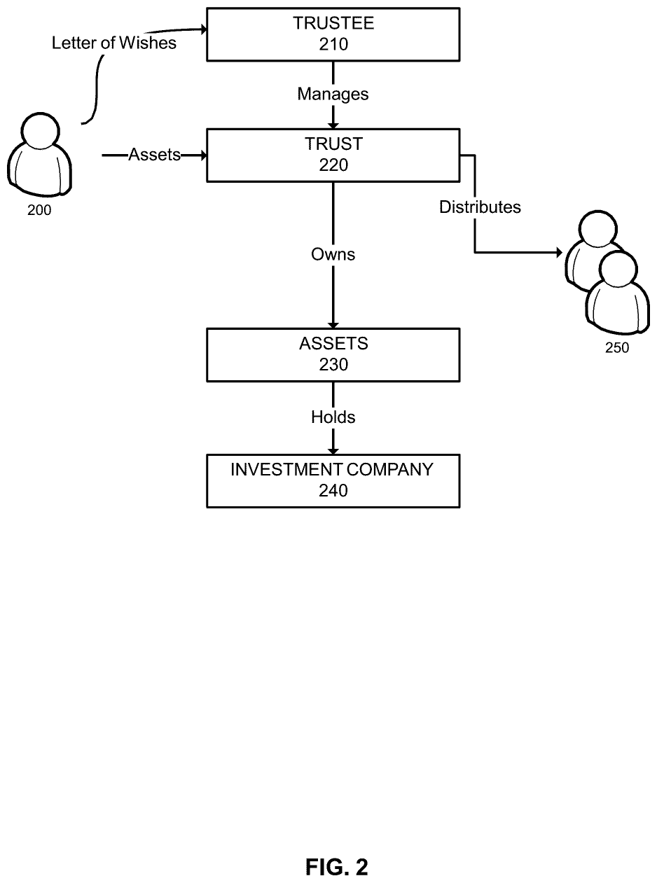

FIG. 2 illustrates an exemplar flow of information from a donor 200 (e.g., the person or user establishing a trust) and a trust 220. The donor 200 creates the trust and transfers initial assets 230 (e.g., cash and real property) to the trust. A letter of wishes is provided to the trustee 210. The trust owns the assets 230. Where cash or stocks are involved, an investment company 240 can hold the assets 230 for the trust. Upon occurrence of an event, the trust 220 distributes assets 230 from the trust 220 to the beneficiaries 250 (or recipients) of the trust. An investment company 240 typically has advisors (such as wealth managers) that interface with customers, including donors, users, beneficiaries, recipients, verification contacts, trustees (e.g., trust administrators), and other parties.

A variety of trusts are available; trusts typically fall into one of two categories: revocable or irrevocable. A revocable trust is a trust with provisions that can be altered or canceled dependent on the grantor or the originator of the trust (i.e., donor 200). During the life of the revocable trust, income earned can be distributed to the grantor, and only after death does property transfer to the beneficiaries of the trust. In contrast, an irrevocable trust is a trust where its terms cannot be modified, amended or terminated without the permission of the grantor's named beneficiary or beneficiaries.

### III. TRUST DISTRIBUTION SYSTEM OVERVIEW

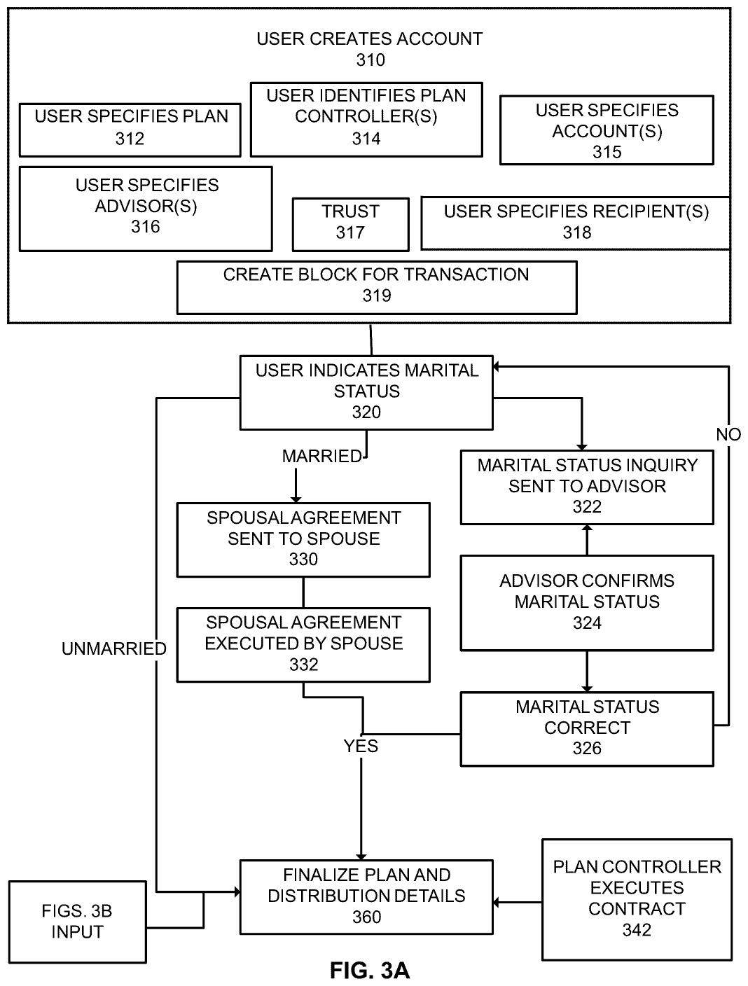

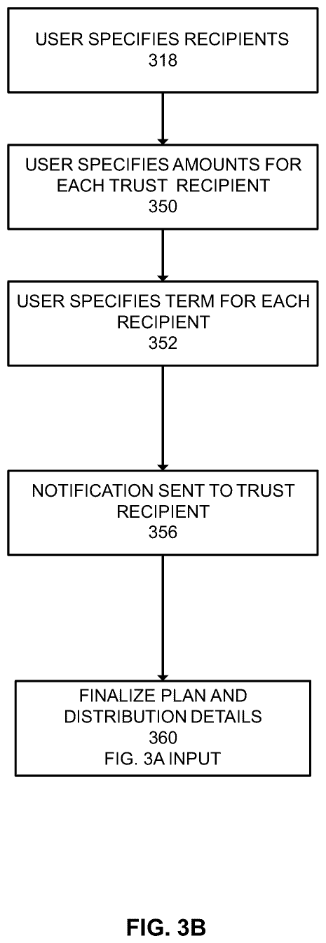

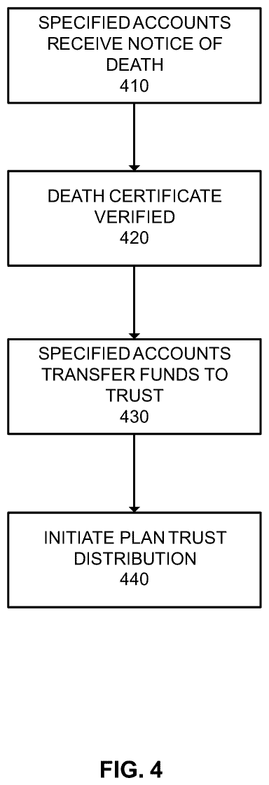

Turning to the disclosed trust distribution system, in an initial process shown in FIG. 3A, a user creates an account 310 within the system. The user is a person creating a trust. During the account creation process, the user specifies a plan 312, identifies one or more plan controllers 314, specifies one or more accounts 315 to be accessed, identifies one or more advisors 316, and identifies one or more recipients 318. During this process, the system creates a block for the blockchain for this transaction 319. The user can also designates whether any of the identified accounts are, or will be, associated with the trust 317. The plan controller 314 is a trust administrator responsible for performing duties associated with disposing of an estate for the user once the user is deceased.

The controllers 314 can act as administrators and can be set-up as a primary administrator and a back-up administrator. The controllers can be set-up at the account level or the recipient level. In the event the recipient has an action coming due, or a disbursement coming due and the system does not receive confirmation from the recipient, the primary administrator will be advised. Once the primary administrator receives notification of a required action for the administrator, the primary administrator can interact with the recipient to ensure the recipient engages with the system as needed for the event. The administrator may also provide feedback to the system regarding the recipient. In some configurations, the administrator has no control over the funds or their distribution in the system.

During the set-up process, the user also indicates a marital status 320. If the user is married, then information about the spouse is entered into the trust distribution system and a spousal consent agreement is sent electronically to the spouse 330. In one configuration, the spouse prints the authorization, signs the authorization 332 in front of a witness or Notary Public, and then returns an electronic copy of the completed document. Return of the electronic copy can occur by any suitable process including, for example, uploading a photo of the signed document via a mobile device. The trust distribution system can then review the document for legibility to ensure the document appended is the authorization and the information required is present and legible. If the information is not legible, the trust distribution system can flag the document for human review and/or notify the person uploading the document that the quality of the document is not sufficient. In another configuration, the spouse creates a separate account with the trust distribution system and accesses an electronic version of the consent agreement. The spouse is then given the opportunity to accept or reject the agreement. In order to complete the acceptance biometric data, such as a fingerprint, may be required. Thus, for example, in a mobile environment, the spouse would choose accept and then be required to swipe a known finger across the fingerprint sensor embedded in the phone.

In one configuration the user identifies an advisor or bank holding cash assets for the user and indicates a marital status. A notification is then sent to the advisor or bank requesting the advisor or bank confirm or indicate a marital status 322 for the user. In response to the marital status inquiry 322, the advisor or bank confirms the marital status 324. In one configuration, for example, the advisor or bank can be presented with an option such as “John Smith—married” with a “confirm YES/NO” option. In another configuration, the advisor or bank can be required to independently indicate a marital status for the user. Once the advisor or bank indicates the marital status of the user, the trust distribution system determines if the marital status is correct 326 by either determining that the advisor has indicated a positive confirmation or has entered the same marital status as the user. If the marital status is correct 326 (YES), then the process proceeds to completion. If the marital status is not correct (NO), then the trust distribution system notifies the user and requests the information be updated. Where the spousal confirmation is sent to a bank, an authorized user of the bank or other bank approved process can be applied.

If the user is unmarried and the advisor or bank confirms 324 that the user in unmarried, then the plan and distribution details are finalized and the plan controller executes the contract 342. The plan controller can have limited or restricted permissions. Permissions for the plan controller can be set to change upon the occurrence of one or more defined events (e.g., incapacity or death of the user). Once all the components are completed, the plan is finalized and distribution details are completed 360.

In FIG. 3B, a process of the user identifying recipients 318 is provided in further detail. Once one or more recipients are identified by the user in the trust distribution system, the user specifies an amount for each recipient 350. A notification can be sent to each recipient at the time the user creates the trust, or upon the occurrence of a qualifying event, indicating that they are identified in the trust distribution system and requesting the recipient confirm contact details.

The process of the user specifying recipients 318 can result in separate blocks of the blockchain for each of the recipients. Any recipient confirmation of contact information can also create blocks of the blockchain.

The user can also specify a term for the distribution 352. For example, the account with the advisor needs to be opened within a period of time from defined event occurrence, i.e. death of the user setting up the trust, and/or held for 12 months, 18 months, 10 years, etc. The process of identifying recipients can be instructed by the user or the plan controller.

The system can review the any documents that are submitted for legibility to ensure the document appended is the authorization and the information required is present and legible. If the information is not legible, the system can flag the document for human review and/or notify the person uploading the document that the quality of the document is not sufficient.

The system is also configurable to provide a news feed to each participant. The newsfeed advises of upcoming actions and provides for a regular request for update (e.g., annual update request). Alerts and notifications can be provided via the system newsfeed, via text message, via push notification, via email, or any other suitable available mechanism.

Unless the trust is revocable and the user terminates the trust early, once the specified accounts associated with the trust distribution system receive a notice of death the process of trust distribution begins. For example, specified accounts receive a notice of death 410. The death certificate is verified 420. If the funds re not already transferred to the trust, the specified accounts transfer funds to the trust 430 and the plan distribution are initiated for the beneficiaries 440. The beneficiary's funds can be provided from any or all of: the user's estate, the user's administrative trust (former revocable trust), any user's pay on death account, or as a recipient of any of the user's life insurance policies. A similar process could occur in the event of incapacity of the user, as will be appreciated by those skilled in the art.

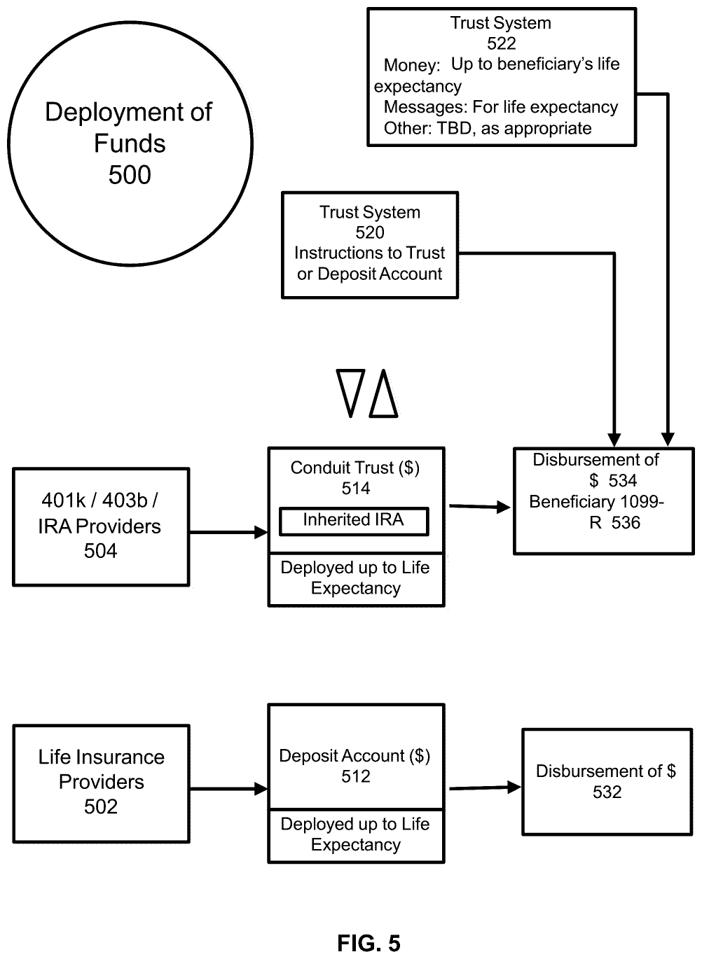

FIG. 5 is a deployment of funds 500 process. In one aspect one or more life insurance provers 502, such as State Farm®, Northwestern Mutual®, Prudential® or New York Life®, deposits money into a deposit account 512. The money deposited is deployable by the trust distribution system up to the life expectancy of the recipient, or over any time frame designated by the trust. Money can be disbursed 532 from the account 512.

In another aspect one or more retirement account providers, such as JP Morgan Chase®, Fidelity®, Vanguard®, Prudential®, or Transamerica®, deposit funds into a conduit trust 514 which is manageable up to the life of the recipient, or over any time frame designated. Funds are disbursable from the conduit trust 514 to the recipient via the trust distribution system. Money, such as money inherited from an IRA, is disbursed 536 and beneficiaries receive appropriate tax forms, e.g. 1099-R forms. The trust distribution system is configurable to provide instructions 520 to a trust account or deposit account. Additionally, the trust distribution system can provide messages 522 to the beneficiary with the disbursement or arrange for appropriate tax forms, e.g., Beneficiary 1099-R, to be provided 536.

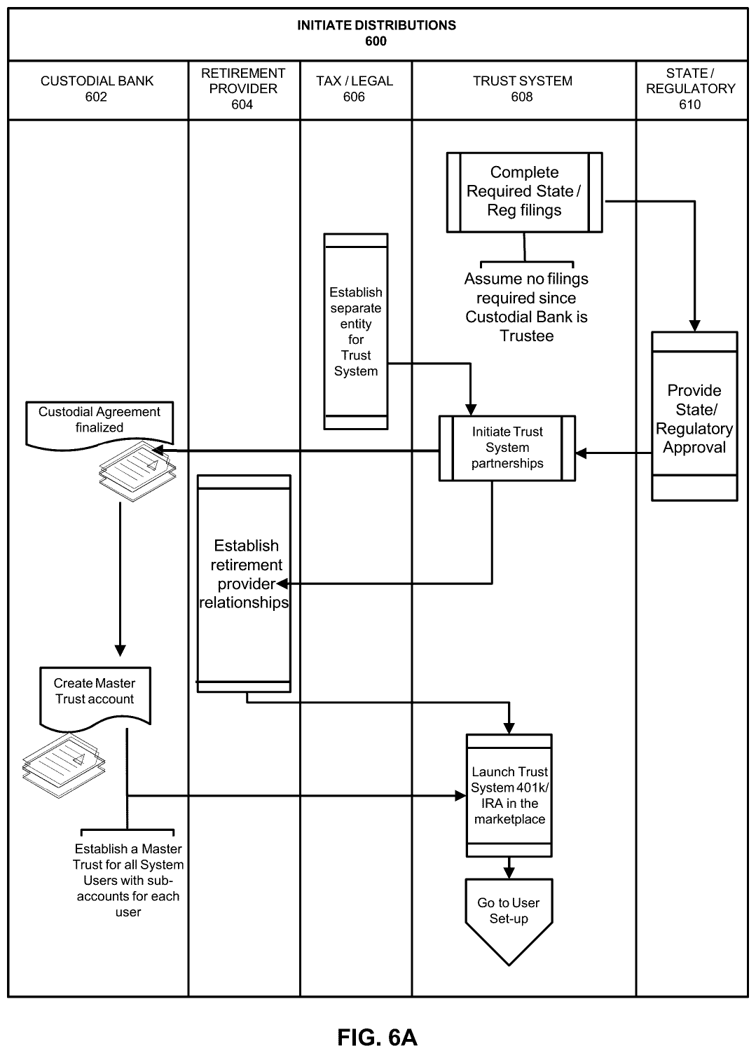

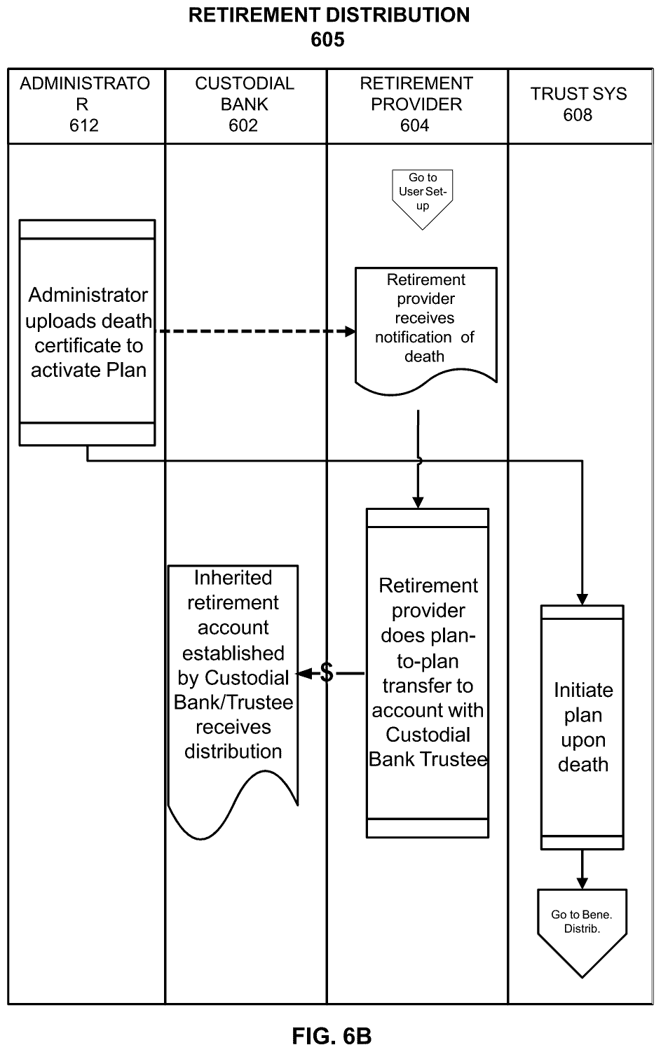

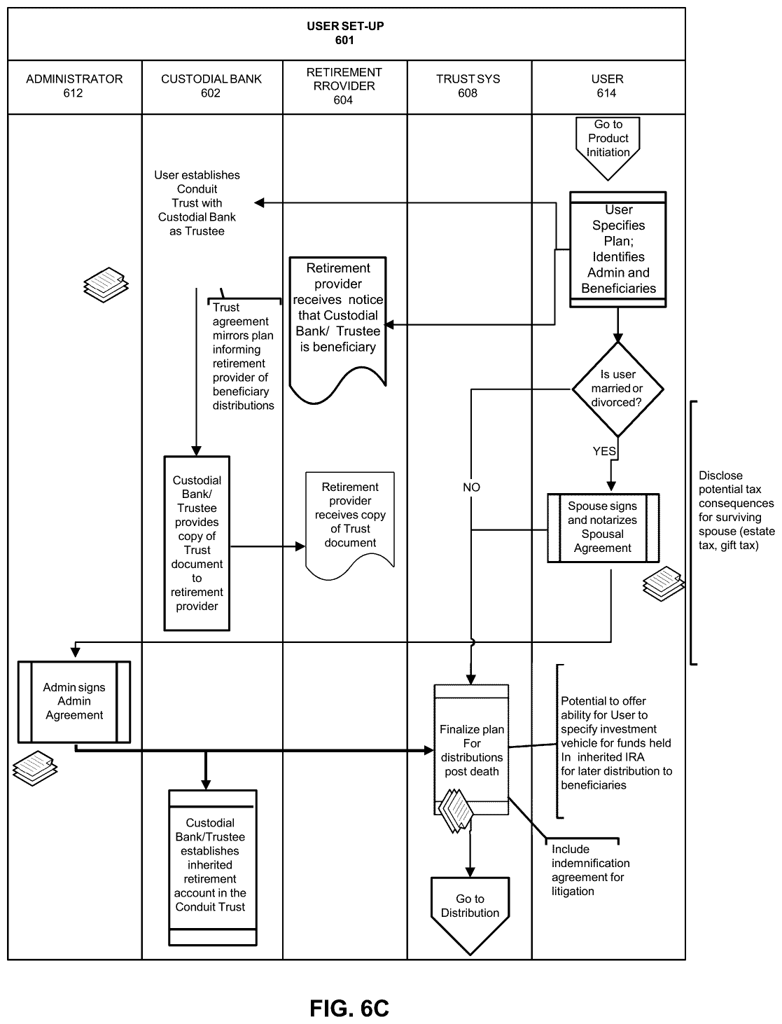

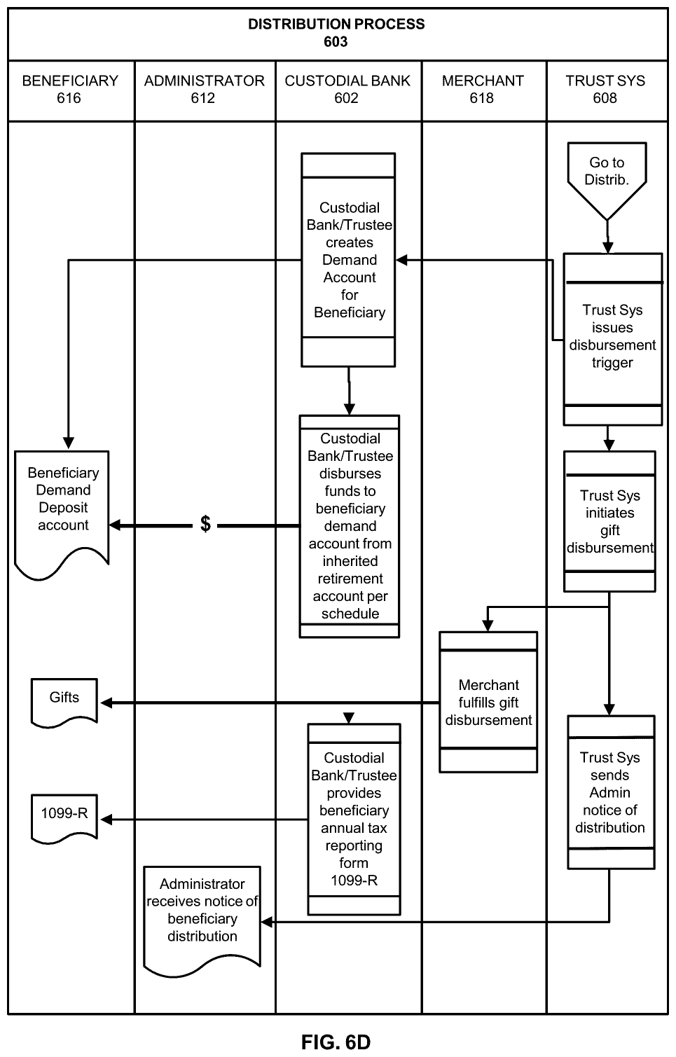

FIGS. 6A-6D are distribution flow diagrams for the trust distribution system. FIG. 6A illustrates an exemplar retirement account distribution process where a user designates a custodial entity (e.g., bank) as trustee to receive funds from the user's retirement account (e.g., IRA, 401k, 403b, etc.) upon death of the user. The funds are then distributed via the disclosed trust distribution system.

The flow diagrams illustrates actions that occur for different users of the trust distribution system over time. Distribution can be initiated 600 from different users including, custodial bank 602, retirement provider 604, tax and/or legal processes 606, trust distribution system 608, state and/or regulatory processes 610, administrator 612, user 614, beneficiary 616, and merchant 618.

The custodial bank 602 is the bank, or other suitably qualified entity, that holds and or handles money or assets to be distributed by for the user by the trust distribution system. The custodial bank 602 can be a bank or trust company selected by the User/Benefactor and the Beneficiary at which the Beneficiary will establish an account into which proceeds of insurance on the life of the User/Benefactor or his or her 401(k)/403(b)/IRA retirement benefits will be made payable following his or her death.

The retirement provider 604 is the financial institution, or other suitably qualified entity, that manages and/or administers assets and/or retirement benefits in a retirement account for the user.

The tax and/or legal processes 606 is any process conducted with respect to any reporting requirements to the US Federal and US state tax authorities relating to the payment, receipt and disbursement/administration of any life insurance proceeds and/or retirement benefits.

The trust distribution system 608 is the trust distribution disclosed herein.

The state and/or regulatory processes 610 include any processes undertaken with respect to regulation of any bank or trust company, or suitably qualified entity, that will receive and/or administer insurance proceeds or 401(k)/403(b)/IRA retirement benefits in accordance with any custodial or trust agreement.

The administrator 612 is the trust distribution system disclosed or a designee of the trust distribution system that will direct payment of funds in any bank or trust account to the beneficiaries.

The user 614, is the user of the trust distribution system that has established a trust, identified assets and named beneficiaries as disclosed herein. The user is also the benefactor or donor 200 as shown in FIG. 2.

The beneficiary 616, is any person or entity that the user identifies to receive proceeds from life insurance policies and/or 401(k)/403(b)/IRA retirement benefits.

The merchant 618 is a seller or provider of merchandise or services that the user may want to deliver merchandise or services after his or her death to one or more beneficiaries. Provision of merchandise or services can be in addition to, or in lieu of, life insurance proceeds or 401(k)/403(b)/IRS retirement benefits.

The flow diagram in FIG. 6A illustrates a distribution process. If needed the trust distribution system completes any required state or regulatory filings. The state and regulatory filings are configurable to await approval (if required) from the corresponding state or regulatory authority. Where a custodial bank is trustee, then no filing is likely required. Once any approval that is required is obtained, or where no approval is required, the trust distribution system can initiate partnerships. A separate entity, e.g., a conduit trust, can be established for the trust distribution system.

As will be appreciated by those skilled in the art, a trust distribution system would be required with respect to a bequest of the User/Benefactor's 401(k)/403(b)/IRA retirement benefits, because those benefits would have to be distributed to an “inherited IRA, from which they would be paid out to a qualified trust, such as a so-called “conduit trust,” of which the Beneficiary would be the sole beneficiary and receive payments over his or her life expectancy as of the date of the User/Benefactor's death, in order to qualify for income tax deferral for the benefits. A conduit trust is a separate entity for income tax purposes, but the benefits may be taxable to the beneficiary when paid to him or her and deductible by the trust.

Once the trust distribution system partnerships are initiated, the custodial bank can finalize any custodial agreements required, and the retirement provider can establish retirement provide relationships. After the custodial agreements are finalized, a master trust account is created for all system user with sub-accounts for each user. The trust distribution system is then launched in the marketplace. Following that process a user set-up process, such as shown in FIG. 6C, can be initiated.

Turning to FIG. 6B, a retirement account distribution 605 upon death process is illustrated. The retirement provider receives notification of death of the account holder (e.g., from the administrator) and transfers the funds from the retirement account to an account with the identified custodial bank trustee. The administrator uploads a death certificate to activate the plan at which point the plan is initiated and the process proceeds to the beneficiary distribution process, such as shown in FIG. 6D.

FIG. 6C illustrates a user set-up 601. The user specifies a plan, identifies one or more plan administrators and one or more beneficiaries. The user indicates a marital status. If required, the spouse completes a spousal agreement. The spousal agreement can be notarized or legalized as needed or desirable. The spouse may also be advised of potential consequences of the plan, e.g., tax consequences. The user establishes a conduit trust with a custodial bank as trustee. The trust agreement mirrors plan and informs the retirement provider of the beneficiary distributions. The custodial bank/trustee provides a copy of trust documents to the retirement provider and the custodial bank/trustee establishes an inherited retirement account in the conduit trust.

Turning to FIG. 6D, a money and gift distribution process 603 is shown. The custodial bank and/or trustee creates one or more demand accounts for one or more beneficiaries. The custodial bank and/or trustee disburses funds to one or more beneficiary demand accounts from an inherited retirement account per a schedule. The schedule can be provided by the owner of the account prior to death. The custodial bank and/or trustee then provides appropriate tax forms such as 1099-R. The trust distribution system is configurable to issue disbursement triggers, initiate one or more gift disbursements, and send one or more notices of distribution to, for example, an administrator. One or more merchants can fulfill one or more gift disbursements. A deposit account, gifts and/or 1099-R can be received by the beneficiary. In addition to, or instead of a gift, the system can send a voice or video message or electronic communication later in time following the same process as the gift disbursement.

### IV. EXAMPLES

### Example 1

In a first example, the trust distribution system user has set-up a legal trust as shown in FIG. 2. The user then enters into an agreement (i.e. contracts) with the trust distribution system provider to administer the trust. The funds for the trust are distributed from the trust that the user has set-up to the trust distribution system upon death of the user. The funds are distributed to recipients as outlined in the trust by the user, e.g., $5,000 per month for 10 years, etc.

### Example 2

A user sets-up a legal trust as shown in FIG. 2. In addition to the fund distribution process the user identifies a variety of gifts to be delivered at a future time to one or more beneficiaries (e.g., a string of pearls for a daughter's 21st birthday, a leather briefcase for projected college graduation, etc.).

### Example 3

A user sets-up a legal trust as shown in FIG. 2. In addition to the fund distribution process the user creates written, audio or video messages to be delivered at a later time by the system to one or more beneficiaries.

### V. COMPUTING ENVIRONMENT OVERVIEW

The systems and methods according to aspects of the disclosed subject matter may utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as an iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at sometimes be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

Additionally, a communication system of the disclosure comprises: a sensor as disclosed; a server computer system; a measurement module on the server computer system for permitting the transmission of a measurement from a detection device over a network; at least one of an API (application program interface) engine connected to at least one of the detection device to create a message about the measurement and transmit the message over an API integrated network to a recipient having a predetermined recipient user name, an SMS (short message service) engine connected to at least one of the system for detecting physiological parameters and the detection device to create an SMS message about the measurement and transmit the SMS message over a network to a recipient device having a predetermined measurement recipient telephone number, and an email engine connected to at least one of the detection device to create an email message about the measurement and transmit the email message over the network to a recipient email having a predetermined recipient email address. Communications capabilities also include the capability to communicate and display relevant performance information to the user, and support both ANT+ and Bluetooth Smart wireless communications. A storing module on the server computer system for storing the measurement in a detection device server database can also be provided. In some system configurations, the detection device is connectable to the server computer system over at least one of a mobile phone network and an Internet network, and a browser on the measurement recipient electronic device is used to retrieve an interface on the server computer system. In still other configurations, the system further comprising: an interface on the server computer system, the interface being retrievable by an application on the mobile device. Additionally, the server computer system can be configured such that it is connectable over a cellular phone network to receive a response from the measurement recipient mobile device. The system can further comprise: a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement. Additionally, the system can be configured to comprise: a transmissions module that transmits the measurement over a network other than the cellular phone SMS network to a measurement recipient user computer system, in parallel with the measurement that is sent over the cellular phone SMS network.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed is:

1. A system comprising:
at least one hardware processor;
an immutable ledger-based platform;
a server computer for a tokenized trust issuing entity; and
a requestor user device, an advisor user device and a recipient user device wherein the immutable ledger-based platform is in network communication with the server computer for the tokenized trust issuing entity and at least one of the requester user device, advisor user device and recipient user device, wherein the immutable ledger-based platform facilitates a remote transaction of tokenized trust between the requestor user device, a first controller, and the recipient user device, wherein the immutable ledger-based platform deploys tokenized agreements for the tokenized trust for the tokenized trust issuing entity, wherein the tokenized agreements are smart contracts including at least one bundle of rights, wherein each of the at least one bundle of rights designates at least one recipient user, at least one advisor user, at least one requestor user, and a first triggering event and a second triggering event; and
a memory storing instructions that, when executed by the at least one hardware processor, causes the at least one hardware processor to perform operations in a networked computing environment comprising:
receiving a request to create a trust from a requestor for the immutable ledger-based platform;
creating a trust blockchain for the immutable ledger-based platform;
obtaining recipient information from the requestor for the immutable ledger-based platform;
obtaining instructions for distribution of one or more distribution objects from the requestor for the recipient, wherein the one or more identified distribution objects are selected from money, merchandise, video messages, voice messages, and text messages;
obtaining identification of a first condition for distribution of a first distribution object from the requestor;
appending the first condition for distribution of the first distribution object to the trust voucher blockchain;
obtaining a second condition for distribution of the first distribution object from the requestor;
appending the second condition for distribution of the first distribution object to the trust voucher blockchain;
appending the recipient information for the first distribution object to a trust blockchain for the immutable ledger-based platform;
appending the one or more identified distribution objects for the recipient to the trust block chain for the immutable ledger-based platform;
repeating the steps of obtaining identification, appending the first condition for distribution, obtaining the second condition for distribution, and appending the second condition for distribution for each identified distribution object;
obtaining one or more trust source information from the requestor;
obtaining one or more trust source distribution instructions from the requestor for the recipient;
obtaining a plurality of trust source distribution triggering events for each one of the one or more trust source distribution instructions from the requestor for the recipient;
appending the one or more trust source information to the trust blockchain;
appending the one or more trust source distribution instructions for the recipient to the trust block chain;
appending the plurality of trust source distribution triggering events for each one of the one or more trust source distribution instructions to the trust block chain;
verifying an identity of the requestor and in response to verifying the identity of the requestor, determining a requestor digital certificate for proving authenticity of the requestor;
verifying an identity of the recipient and in response to verifying the identity of the recipient, determining a recipient digital certificate for proving authenticity of the recipient;
obtaining an advisor information from the requestor;
appending the advisor information to the trust blockchain;
generating the trust wherein the trust comprises a control logic configured to control access to the trust based on obtaining verification of a condition for trust and the control logic is executed using the hardware processor configured to receive a first instruction to administer the trust;
appending the trust to the trust blockchain;
receiving a notification of an occurrence of a distribution triggering event;
determining if the distribution triggering event corresponds to one of the plurality of the identified distribution triggering events or one of the plurality of trust source distribution triggering events; and
at least one of delivering the trust source distribution, the video message, the voice message, and the text message or instructing a merchant to deliver merchandise.

2. The system of claim 1 wherein the instructions further comprises one or more of:
obtaining a marital status from the requestor;
obtaining spousal information from the requestor;
obtaining spousal agreement from a spouse of the requestor;
confirming the marital status;
generating a marital status completion block; and
appending the marital status completion block to the trust blockchain.

3. The system of claim 1 wherein the instructions further comprises one or more of:
obtaining a personalization input from the requestor for the one or more recipients;
generating a personalization completion block; and
uploading the personalization completion block to the trust blockchain.

4. The system of claim 1 wherein the instructions further comprises one or more of:
creating an account set-up form;
creating a management agreement;
creating an account transfer form;
creating a margin agreement;
creating an options agreement;
creating a money movement agreement;
generating a distribution documents completion block containing the one or more created forms and agreements; and
appending the distribution documents completion block to the trust blockchain.

5. The system of claim 4 wherein the system is configured to generate a unique hash value for each of the documents reviewed and signed based on a secure hash algorithm in real time and store each unique hash value on the trust blockchain.

6. The system of claim 5 wherein the instructions further comprises one or more of:
notifying the recipient of a distribution under the trust;
obtaining a distribution location from the recipient;
making a distribution to the recipient;
generating a distribution delivery completion block; and
appending the distribution delivery completion block to the trust blockchain.

7. A computer-implemented method for account creation in a networked computing environment, the method comprising:
receiving a request to create a trust from a requestor;
creating a trust blockchain;
obtaining recipient information from the requestor;
obtaining instructions for distribution of one or more distribution objects from the requestor for the recipient, wherein the one or more identified distribution objects are selected from money, merchandise, video messages, voice messages, and text messages;
obtaining identification of a first condition for distribution of a first distribution object from the requestor;
appending the first condition for distribution of the first distribution object to the trust voucher blockchain;
obtaining a second condition for distribution of the first distribution object from the requestor;
appending the second condition for distribution of the first distribution object to the trust voucher blockchain;
appending the recipient information for the first distribution object to a trust blockchain;
appending the one or more identified distribution objects for the recipient to the trust block chain;
repeating the steps of obtaining identification, appending the first condition for distribution, obtaining the second condition for distribution, and appending the second condition for distribution for each identified distribution object;
obtaining one or more trust source information from the requestor;
obtaining one or more trust source distribution instructions from the requestor for the recipient;
obtaining a plurality of trust source distribution triggering events for each one of the one or more trust source distribution instructions from the requestor for the recipient;
appending the one or more trust source information to the trust blockchain;
appending the one or more trust source distribution instructions for the recipient to the trust block chain;
appending the plurality of trust source distribution triggering events for each one of the one or more trust source distribution instructions to the trust block chain;
obtaining an advisor information from the requestor;
appending the advisor information to the trust blockchain;
generating the trust wherein the trust comprises a control logic configured to control access to the trust based on obtaining verification of a condition for trust and the control logic is executed using the hardware processor configured to receive a first instruction to administer the trust;
appending the trust to the trust blockchain;
receiving a notification of an occurrence of a distribution triggering event;
determining if the distribution triggering event corresponds to one of the plurality of the identified distribution triggering events or one of the plurality of trust source distribution triggering events;
verifying an identity of the requestor and in response to verifying the identity of the requestor, determining a requestor digital certificate for proving authenticity of the requestor;
verifying an identity of the recipient and in response to verifying the identity of the recipient, determining a recipient digital certificate for proving authenticity of the recipient; and
at least one of delivering the trust source distribution, the video message, the voice message, and the text message or instructing a merchant to deliver merchandise.

8. The computer-implemented method of claim 7 wherein the instructions further comprises one or more of:
obtaining a marital status from the requestor;
obtaining spousal information from the requestor;
obtaining spousal agreement from a spouse of the requestor;
confirming the marital status;
generating a marital status completion block; and
appending the marital status completion block to the trust blockchain.

9. The computer-implemented method of claim 8 wherein the instructions further comprises one or more of:
obtaining a personalization input from the requestor for the one or more recipients;
generating a personalization completion block; and
uploading the personalization completion block to the trust blockchain.

10. The computer-implemented method of claim 8 wherein the instructions further comprises one or more of:
creating an account set-up form;
creating a management agreement;
creating an account transfer form;
creating a margin agreement;
creating an options agreement;
creating a money movement agreement;
generating a distribution documents completion block containing the one or more created forms and agreements; and
appending the distribution documents completion block to the trust blockchain.

11. The computer-implemented method of claim 10 wherein the instructions further
notifying the recipient of a distribution under the trust;
obtaining a distribution location from the recipient;
making a distribution to the recipient;
generating a distribution delivery completion block; and
appending the distribution delivery completion block to the trust blockchain.
